(19) United States
(12) Patent Application Publication
(10) Pub. No.: US 2009/0284189 A1
(43) Pub. Date: Nov. 19, 2009

(54) REGULATOR AND METHOD FOR REGULATING A CONTINUOUSLY VARIABLE ELECTRICAL GEARBOX

(76) Inventor: Johannes Reinschke, Nurnberg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/305,485

(22) PCT Filed: May 29, 2007
(86) PCT No.: PCT/EP2007/055160

§ 371 Date: Dec. 18, 2008

(30) Foreign Application Priority Data
Jun. 23, 2006 (DE) 10 2006 028 940.4

(51) Int. Cl. H02P 5/46; H02K 51/00; H02K 7/116

(52) U.S. Cl. 318/41; 310/102 R; 310/83

(57) ABSTRACT

A continuously variable electrical gearbox has a rotatable rotor, a stator, an interrotor with a first and a second cage conducting first and second magnetisation currents. A regulator has a decoupling network connected in series with the gearbox having as input parameters: set values for the first and second magnetisation current levels, set values for the first and second torque between the rotor and interrotor and interrotor and stator and as output parameters: rotor current and stator current, a recording device for recording first and second magnetisation currents and a feedback system for feedback of first and second magnetisation currents as input parameters from the decoupling network. Rotor current and stator current are determined from the input parameters: set values for the first and second magnetisation current levels, set values for the first and second torque, first and second magnetisation currents are recorded and fed back to the decoupling network.

### CROSS-REFERENCE TO RELATED APPLICATIONS

This application is a U.S. National Stage Application of International Application No. PCT/EP2007/055160 filed May 29, 2007, which designates the United States of America, and claims priority to German Application No. 10 2006 028 940.4 filed Jun. 23, 2006, the contents of which are hereby incorporated by reference in their entirety.

### TECHNICAL FIELD

The invention relates to a regulator and a method for regulating an electric variable transmission.

### BACKGROUND

An electric variable transmission EVT is an electric machine, which consists of two electromagnetically coupled asynchronous machines—hereafter referred to as rotor ASM and stator ASM. Such a transmission can replace the clutch, wiring, starter and generator for example in a motor vehicle.

Both the rotor ASM and the stator ASM have to be supplied with a corresponding rotor or stator current. This requires a regulator and a corresponding method, according to which the regulator operates. If the rotor ASM and the stator ASM were not coupled electromagnetically but simply mechanically, it would be possible to use conventional regulation methods and known regulators, e.g. field-oriented regulators, for both machines. [S. W. Leonhard: Control of Electrical Driver, Springer 2001].

### SUMMARY

According to various embodiments, a method and a corresponding regulator for regulating an electric variable transmission can be specified.

According to an embodiment, a regulator for regulating an electric variable transmission, with the transmission comprising two coupled asynchronous machines, each comprising: a rotatable rotor, which can be supplied with rotor current to generate a first electromagnetic field, a stator, which can be supplied with stator current to generate a second electromagnetic field, an interrotor interacting with the first and second electromagnetic fields, with a first and second cage for conducting first and second magnetization currents induced by the first and second electromagnetic field, with the rotor and interrotor interacting by way of a first electric torque and the interrotor and stator interacting by way of a second electric torque, and wherein the regulator comprises: a decoupling network, which can be connected upstream of the electric transmission, with the input variables: setpoint value for level of first magnetization current and setpoint value for level of second magnetization current, setpoint value for first torque and setpoint value for second torque and the output variables: rotor current and stator current, a recording facility to record the first and second magnetization currents, a feedback facility to feed back the first and second magnetization currents as input variables of the decoupling network.

According to a further embodiment, the recording facility can be an observer simulating the first and second magnetization currents in respect of regulation. According to a further embodiment, the regulator may comprise: a machine coupling model to determine an interrotor coupling current from the first and second magnetization currents, a rotor controller to determine the rotor current from the interrotor coupling current, the phase of the first magnetization current, the setpoint values for the level of the first magnetization current, and for the first torque, a stator controller to determine the stator current from the interrotor coupling current, the phase of the second magnetization current, the setpoint values for the level of the second magnetization current and for the second torque. According to a further embodiment, both asynchronous machines can be coupled mechanically in the transmission. According to a further embodiment, both asynchronous machines may have a shared interrotor in the transmission. According to a further embodiment, the interrotor may be arranged concentrically between the stator and rotor and the first and second cages being arranged concentrically in the transmission. According to a further embodiment, the first and second cages may have a shared yoke in the transmission.

According to another embodiment, a method for regulating an electric variable transmission, with the transmission comprising two coupled asynchronous machines, each having: a rotatable rotor, which can be supplied with rotor current to generate a first electromagnetic field, a stator, which can be supplied with stator current to generate a second electromagnetic field, an interrotor interacting with the first and second electromagnetic fields, with a first and second cage for conducting first and second magnetization currents induced by the first and second electromagnetic fields, with the rotor and interrotor interacting by way of a first electric torque and the interrotor and stator interacting by way of a second electric torque, the method may comprise the steps of: determining by a decoupling network, which can be connected upstream of the electric transmission, output variables: rotor current and stator current from input variables: setpoint value for level of first magnetization current, setpoint value for level of second magnetization current, setpoint value for first torque and setpoint value for second torque, recording by a recording facility the first and second magnetization currents, feeding back by a feedback facility the first and second magnetization currents as input variables to the decoupling network.

According to a further embodiment, the first and second magnetization currents can be determined by an observer simulating these in respect of regulation and operating as a recording facility. According to a further embodiment, in the decoupling network: a machine coupling model may determine an interrotor coupling current from the first and second magnetization currents, a rotor controller may determine the rotor current from the interrotor coupling current, the phase of the first magnetization current, the setpoint values for level of the first magnetization current and for first torque, a stator controller may determine the stator current from the interrotor coupling current, the phase of the second magnetization current, the setpoint values for level of the second magnetization current and for second torque. According to a further embodiment, both asynchronous machines may be coupled mechanically in the transmission. According to a further embodiment, both asynchronous machines may have a shared interrotor in the transmission. According to a further embodiment, the interrotor may be arranged concentrically between the stator and rotor and the first and second cages being arranged concentrically in the transmission. According to a further embodiment, the first and second cages may have a shared yoke in the transmission.

### BRIEF DESCRIPTION OF THE DRAWINGS

For a further description of the invention, see also the exemplary embodiments in the drawings. These respectively contain schematic diagrams, in which:

FIG. 1 shows an amplitude-phase diagram (space vector diagram) of the stator and magnetization currents of a conventional induction machine,

FIG. 2 shows an input-output diagram of a conventional induction machine decoupled by field-oriented regulation,

FIG. 3 shows a field-oriented regulator and a machine model of an induction machine of a conventional induction motor,

FIG. 4 shows the field-oriented regulator from FIG. 3 in detail,

FIG. 5 shows the machine model from FIG. 3 in detail,

FIG. 6 shows a space vector diagram of the currents in an EVT,

FIG. 7 shows an abbreviated input-output block diagram compared with FIG. 2 of an induction machine decoupled by field-oriented regulation,

FIG. 8 shows an abbreviated input-output block diagram of an EVT decoupled by field-oriented regulation,

FIG. 9 shows a simulink model of an EVT with FOC,

FIG. 10 shows the regulator for the inner machine from FIG. 9,

FIG. 11 shows the regulator for the outer machine from FIG. 9,

FIG. 12 shows the machine coupling model from FIG. 9,

FIG. 13 shows the model of the stator ASM from FIG. 9,

FIG. 14 shows the model of the rotor ASM from FIG. 9,

### DETAILED DESCRIPTION

According to various embodiments, as the regulator records the first and second magnetization currents in the interrotor or its first and second cages, the regulator therefore operates in a field-oriented manner. The magnetization currents differ here from the currents actually flowing in the cages, but are related to these. Once the magnetization currents have been recorded, they are also fed back by the feedback facility as input variables of the decoupling network to said decoupling network and used for regulation. This measure allows decoupling of the two asynchronous machines and therefore also quasi-instantaneous torque regulation in the case of non-vanishing magnetization currents.

Current variables here are complex current vectors in the fixed stator coordinate system characterized by respectively time-dependent levels and phases. The complex current vectors can be converted in the known manner to third-phase currents.

Compared with the field-oriented regulation of a single asynchronous machine, where only the phase of the magnetization current has to be observed, with the regulator according to various embodiments, the level and phase of the first and second magnetization currents have to be recorded.

Decoupling of the two asynchronous machines is carried out by the decoupling network, which has rotor current and stator current as separate output variables. The decoupling network is connected upstream of the electric transmission.

Direct recording of the first and second magnetization currents by the recording facility can be problematic in respect of taking measurements. The recording facility can therefore in particular be an observer simulating the first and second magnetization currents in respect of regulation. The two asynchronous machines are hereby represented in the observer by a so-called machine model, to determine the first and second magnetization currents, in the first and second air gaps of the first and second asynchronous machines. In contrast to an observer for a single asynchronous machine the observer here has to determine the level of the magnetization current as well as the phase. A corresponding observer is therefore more complex but can be of similar structure to the observer for a single asynchronous machine.

The decoupling network in the regulator can be embodied in particular as claimed in claim 3. As the interrotor in an EVT is responsible for the electromagnetic coupling between the two asynchronous machines, a so-called interrotor coupling current flows therein. This is determined in a machine coupling model. Knowledge of the interrotor coupling current in turn allows there to be a separate rotor controller and stator controller in the regulator, which are decoupled from one another. A corresponding regulator can then be modular, with the result that the regulator has a simpler and clearer structure.

In particular the regulator operates particularly favorably for a transmission, in which the interrotor is arranged concentrically between the stator and the rotor and the first and second cages are arranged concentrically. This means that the entire asynchronous machine is arranged concentrically. It is questionable whether a non-concentric arrangement is at all possible.

The regulator can be deployed in particular in an EVT, in which the first and second cages have a shared yoke in the interrotor. The first and second cages are then “close” to one another in such a manner that one magnetic coupling, in other words a “strong coupling” is present, instead of two electromagnetically separate machines. The two asynchronous machines are then strongly coupled and the interrotor can be designed to be particularly small. This allows the most compact structure possible.

In respect of the method the object is achieved by a method as claimed in claim 8. The method according to various embodiments and its advantages have already been described in relation to the regulator.

The field-oriented regulation or field-oriented control FOC of an electric variable transmission is described below. This is based on the field-oriented regulation of an induction machine according to [BLA72] (“F. Blaschke: Das Verfahren der Feldorientierung zur Regelung der Asynchronmaschine. (Field-orientation method for regulating the asynchronous machine) Siemens Forschungs- und Entwicklungsbericht (Research and Development Report) vol. 1, no. 172, Springer 1972, pages 184 to 193”). Field-oriented regulation of an induction machine can include a static, non-linear decoupling prefilter and an observer (machine model) for the flux angle. This basic framework can be completed by a (largely) linear control signal prefilter and a linear, stabilizing feedback.

A proposed static non-linear decoupling prefilter for the field-oriented regulation of the EVT is set out below. In a first approach it can be assumed that the observer is an ideal observer for the level and phase of the inner and outer magnetization currents (flux connection), in other words these variables are known or can be measured precisely.

First the field-oriented regulation of an induction machine is set out and the most important aspects are outlined for transfer to the EVT. Field-oriented regulation is then transferred to the EVT.

The bases for field-oriented regulation of an induction machine are set out below. The determining equations in a fixed stator reference system are the electric torque

$$T = {K}_{1} \cdot {[ {\vec{i}}_{s}^{s} ]}^{T} D ( \frac{π}{2} ) {\vec{λ}}_{r}^{s} , where {K}_{1} := \frac{3}{2} p . \qquad Equ . 3$$

The following applies for rotor voltage

$$0 = {R}_{r} \cdot {\vec{i}}_{r}^{s} + \frac{d {\vec{λ}}_{r}^{s}}{d t} - ω \cdot D ( \frac{π}{2} ) {\vec{λ}}_{r}^{s} , \qquad Equ . 4$$

where ω is the angular velocity of the rotor. The rotor and stator fluxes are

\vec{λ}ᵣ^{s}=\tilde{L}·\vec{i}_{μ}^{s}+L_{rσ}·\vec{i}ᵣ^{s}, \vec{λ}ₛ^{s}=\tilde{L}·\vec{i}_{μ}^{s}+L_{sσ}·\vec{i}ₛ^{s}. Equ 5

By appropriate transformation it is possible to eliminate the leakage inductances L_{rσ} and L_{sσ}, with the result that Equ. 5 is simplified to

\vec{λ}^{s}:=\vec{λ}ᵣ^{s}=\vec{λ}ₛ^{s}=L·\vec{i}_{μ}^{s}. Equ. 6

The magnetization current \vec{i}_{μ}^{s} introduced in Equ. 5 is defined by

\vec{i}_{μ}^{s}=\vec{i}ₛ^{s}+\vec{i}ᵣ^{s}. Equ. 7

To simplify the determining equations all the rotor currents and fluxes are first eliminated, with the result that only the stator and magnetization currents remain in the equations.

Inserting Equ. 6 in Equ. 3 gives

$$T = {K}_{2} \cdot {[ {\vec{i}}_{s}^{s} ]}^{T} D ( \frac{π}{2} ) {\vec{i}}_{μ}^{s} , where {K}_{2} := {K}_{1} \cdot L . \qquad Equ . 8$$

Inserting Equ. 6 and Equ. 7 in Equ. 4 and dividing by Rᵣ gives

$${\vec{i}}_{μ}^{s} + τ \frac{d {\vec{i}}_{μ}^{s}}{d t} - τ \cdot ω \cdot D ( \frac{π}{2} ) {\vec{i}}_{μ}^{s} = {\vec{i}}_{s}^{s} , where τ := \frac{L}{{R}_{r}} . \qquad Equ . 9$$

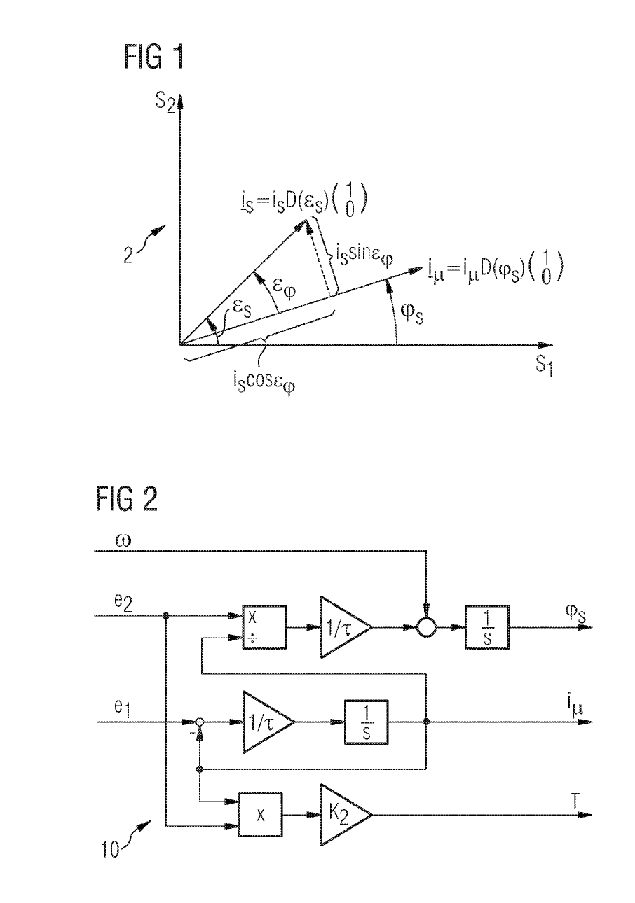

FIG. 1 shows the level and phase diagram of the stator and magnetization currents of an induction machine in a two-dimensional coordinate system 2. In a second simplification step the vectorial stator and magnetization currents are replaced by their amplitudes and phases. The torque equation Equ. 8 then becomes

T=K₂·i_{μ}·(iₛ·sin ε^{φ}), where ε^{φ}:=ε^{s}−φ^{s}. Equ. 10

Splitting Equ. 9 into a determining equation for the amplitude i_{μ} and the phase φ^{s} (in a fixed stator coordinate system) of the vectorial magnetization current \vec{i}_{μ}^{s} gives

$$\begin{matrix}{i}_{μ} + τ \frac{d {i}_{μ}}{d t} = {i}_{s} \cdot cos {ɛ}^{ϕ} , & Equ . 11 \\ {i}_{μ} \cdot τ \cdot ( \frac{d {ϕ}^{s}}{d t} - ω ) = {i}_{s} \cdot sin {ɛ}^{ϕ} . & Equ . 12\end{matrix}$$

The underlying concept of field-oriented regulation is described below. The aim of the field-oriented regulation of an induction machine is to control the amplitude and phase of the stator current, i.e. iₛ(t) and ε^{s}(t), in such a manner that the trajectory of the required torque is approximated as closely and quickly as possible, while the magnetization current and/or its amplitude is kept at a required value. (This value can vary with the angular velocity ω or the torque T, in other words to avoid overvoltages or to improve engine efficiency, but should initially be assumed to be constant). Looking at Equ. 10 and Equ. 12, this aim can be achieved by

making e₁:=iₛ·cos ε^{φ} equal to the target amplitude of the magnetization current and
making e₂:=iₛ·sin ε^{φ} equal to the target torque divided by the amplitude of the magnetization current multiplied by K₂.

The controlled system 10 according to FIG. 2 is then a decoupled system. FIG. 2 shows the input/output block diagram of an induction machine 10 decoupled by field-oriented regulation. e₁ and e₂ are the control signals or input variables of the induction machine 10 and its output variables are the current torque T, the amplitude of the magnetization current i_{μ} and its phase φ^{s}.

The following input/output response of an induction machine, decoupled by field-oriented regulation, should be noted:
(i) The transfer function of

$$( \begin{matrix}{e}_{1} ( t ) \\ {e}_{2} ( t )\end{matrix} )$$

to i_{μ}(t) is linear and time-invariant.
(ii) The transfer function of

$$( \begin{matrix}{e}_{1} ( t ) \\ {e}_{2} ( t )\end{matrix} )$$

to T(t) is bilinear, i.e. a product function.
(iii) The transfer function of

$$( \begin{matrix}{e}_{1} ( t ) \\ {e}_{2} ( t )\end{matrix} )$$

to φ^{s}(t) is non-linear, i.e. has no specific characteristic.

As shown below, these characteristics are generalized for the configuration of the two asynchronous machines of the EVT. The decoupling described above is achieved by means of an appropriate static, non-linear transfer function (or decoupling network) between the target variables (=control signals)

$$( \begin{matrix}{e}_{1} ( t ) \\ {e}_{2} ( t )\end{matrix} )$$

and the (actual) inputs of the induction machine

$$( \begin{matrix}{i}^{s} ( t ) \\ {ɛ}^{s} ( t )\end{matrix} )$$

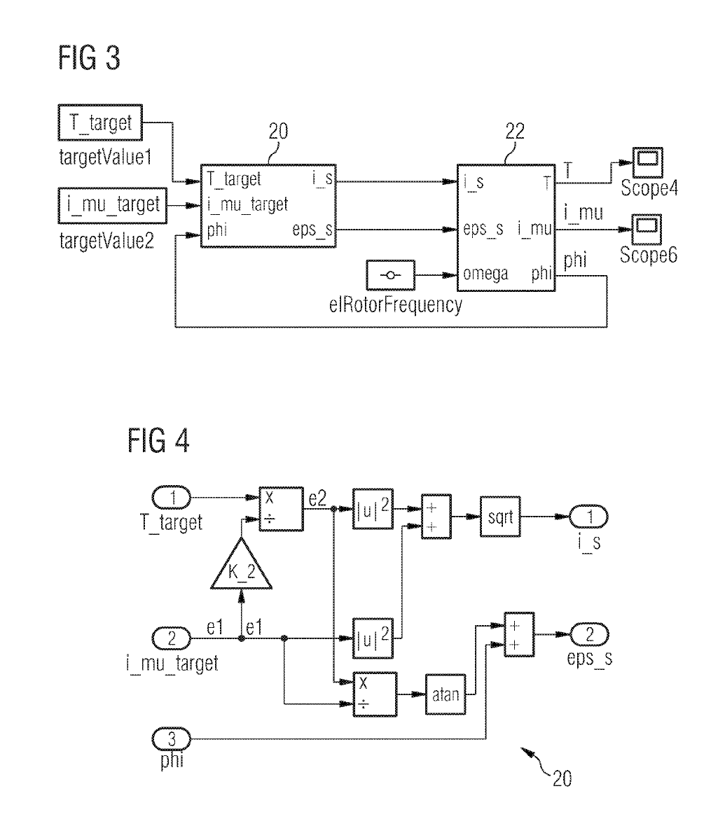

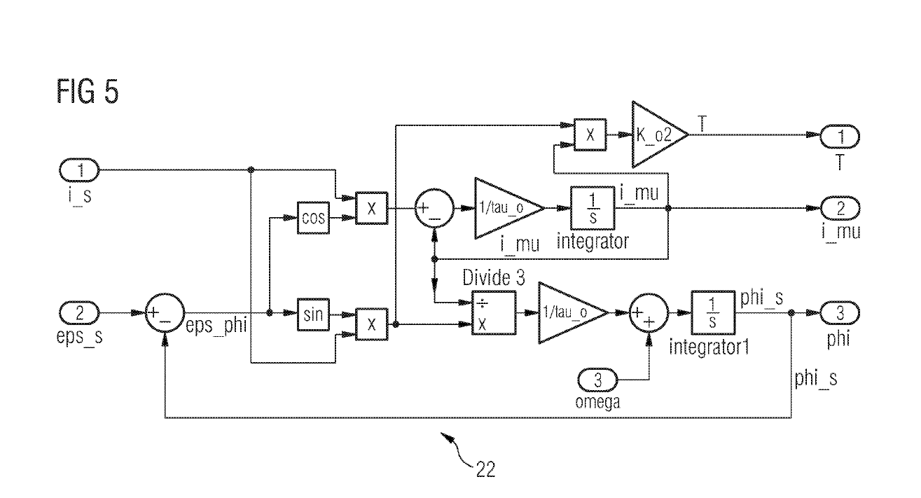

This decoupling network of the field-oriented regulation, combined with the model of the induction machine, is shown in FIG. 3. FIGS. 4 and 5 show the interior of the blocks “field-oriented regulator” and “induction machine” from FIG. 3. FIG. 3 therefore shows the field-oriented regulator 20 on the left and the machine model 22 of an induction motor on the right. FIG. 4 shows the field-oriented regulator 20 from FIG. 3, FIG. 5 the induction machine 22 from FIG. 3, in both instances in detail. As shown in FIG. 4, the decoupling network needs knowledge of the flux angle φ^{s}(t). The flux angle φ^{s}(t) is typically not measured but calculated by the (complete) field-oriented regulator using an appropriate machine model.

As shown in FIG. 3, the field-oriented regulator 20 supplies the induction machine 22 with the stator current, characterized by its amplitude iₛ and phase ε^{s}, which is generated by the decoupling network (not shown FIG. 3) in the regulator 20.

The field-oriented regulation of an electric variable transmission is set out below. The determining equations in a fixed stator reference system are the electric torque at the inner and outer air gaps

$$\begin{matrix}{T}_{i} = {K}_{i 1} \cdot {[ {\vec{i}}_{r}^{s} ]}^{T} D ( \frac{π}{2} ) {\vec{λ}}_{i}^{s} , where {K}_{i 1} := \frac{3}{2} p ; & Equ . 13 \\ {T}_{o} = {K}_{o 1} \cdot {[ {\vec{i}}_{s}^{s} ]}^{T} D ( \frac{π}{2} ) {\vec{λ}}_{o}^{s} , where {K}_{o 1} := \frac{3}{2} p . & Equ . 14\end{matrix}$$

The voltage equations at the interrotor, in other words at the inner and outer cages, are:

$$\begin{matrix}0 = {R}_{i} \cdot {\vec{i}}_{i}^{s} + \frac{d {\vec{λ}}_{i}^{s}}{d t} - {ω}_{2} \cdot D ( \frac{π}{2} ) {\vec{λ}}_{i}^{s} , \\ and & Equ . 15 \\ 0 = {R}_{o} \cdot {\vec{i}}_{o}^{s} + \frac{d {\vec{λ}}_{o}^{s}}{d t} - {ω}_{2} \cdot D ( \frac{π}{2} ) {\vec{λ}}_{o}^{s} . & Equ . 16\end{matrix}$$

The inner and outer air gap flux connections are:

\vec{λ}ᵢ^{s}=Lᵢ·\vec{i}_{iμ}^{s}, \vec{λ}ₒ=Lₒ·\vec{i}_{oμ}^{s}. Equ. 17

The flux connections \vec{λ}ᵢ^{s} and \vec{λ}ₒ^{s} are linked via

−\vec{λ}ₒ^{s}+\vec{λ}_{yh}^{s}+kₛᵣ·\vec{λ}ᵢ^{s}=0, Equ. 18

where

\vec{λ}_{yh}^{s}=L_{yh}(t)·\vec{i}_{yh}^{s}. Equ. 19

The magnetization currents \vec{i}_{iμ}^{s} and \vec{i}_{oμ}^{s} from equation 17 are defined by:

\vec{i}_{iμ}^{s}=\vec{i}ᵢ^{s}+\vec{i}ᵣ^{s}+kₛᵣ\vec{i}_{yh}^{s}, Equ. 20

\vec{i}_{oμ}^{s}=\vec{i}ₛ^{s}\vec{i}ₒ^{s}−\vec{i}_{yh}^{s}. Equ. 21

The determining equations are simplified in a first step below. According to the simplification for the induction motor all the interrotor currents and fluxes are now eliminated, leaving only the rotor and stator currents as well as the magnetization currents in the determining equations. Inserting Equ. 17 in Equ. 13 and Equ. 14 gives

$$\begin{matrix}{T}_{i} = {K}_{i 2} \cdot {[ {\vec{i}}_{r}^{s} ]}^{T} D ( \frac{π}{2} ) {\vec{i}}_{i μ}^{s} , where {K}_{i 2} := {K}_{i 1} \cdot {L}_{i} ; & Equ . 22 \\ {T}_{o} = {K}_{o 2} \cdot {[ {\vec{i}}_{s}^{s} ]}^{T} D ( \frac{π}{2} ) {\vec{i}}_{o μ}^{s} , where {K}_{o 2} := {K}_{o 1} \cdot {L}_{o} . & Equ . 23\end{matrix}$$

Inserting Equ. 17, Equ. 20 and Equ. 21 in Equ. 15 and dividing by Rᵢ gives

$${\vec{i}}_{i μ}^{s} + {τ}_{i} \cdot \frac{d {\vec{i}}_{i μ}^{s}}{d t} - {τ}_{i} \cdot {ω}_{2} \cdot D ( \frac{π}{2} ) {\vec{i}}_{i μ}^{s} = {\vec{i}}_{r}^{s} + {k}_{sr} \cdot {\vec{i}}_{yh}^{s} , \\ where$$

$${τ}_{i} := \frac{{L}_{i}}{{R}_{i}} .$$

Similarly inserting Equ. 17, Equ. 20 and Equ. 21 in Equ. 16 and dividing by Rₒ gives

$${\vec{i}}_{o μ}^{s} + {τ}_{o} \cdot \frac{d {\vec{i}}_{o μ}^{s}}{d t} - {τ}_{o} \cdot {ω}_{2} \cdot D ( \frac{π}{2} ) {\vec{i}}_{o μ}^{s} = {\vec{i}}_{s}^{s} - {\vec{i}}_{yh}^{s} , \\ where \\ {τ}_{o} := \frac{{L}_{o}}{{R}_{o}} . \qquad Equ . 25$$

Finally inserting Equ. 17 and Equ. 19 in Equ. 18 gives

L_{yh}(t)·\vec{i}_{yh}^{s}=Lₒ\vec{i}_{oμ}^{s}−kₛᵣ·Lᵢ\vec{i}_{iμ}^{s}. Equ. 26

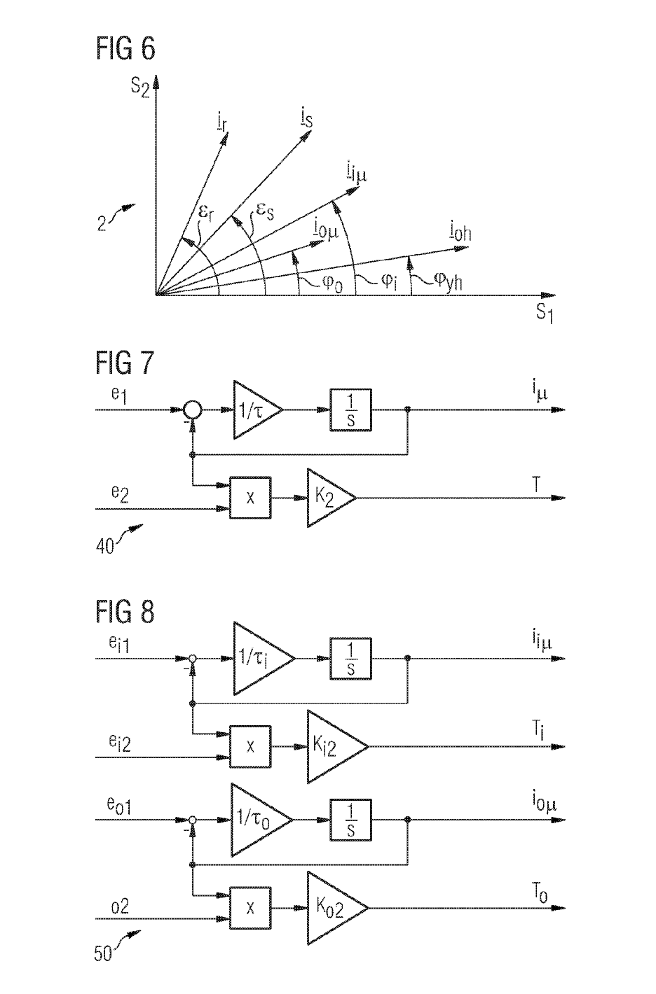

The second simplification step consists of replacing all the vectorial currents with their amplitudes and phases according to FIG. 6. FIG. 6 shows the amplitude and phase diagram of the currents in an EVT in the coordinate system 2 again. The torque equations Equ. 22 and Equ. 23 thus become

Tᵢ=Kᵢ₂·i_{iμ}(iᵣ·sin(εᵣ−φᵢ)), Equ. 27

Tₒ=Kₒ₂·i_{oμ}(iₛ·sin(εₛ−φₒ)). Equ. 28

Splitting Equ. 24 into a determining equation for the amplitude i_{iμ} and phase φᵢ (in a fixed stator coordinate system) of the vectorial magnetization current \vec{i}_{iμ}^{s} gives

$$\begin{matrix}{i}_{i μ} + {τ}_{i} \cdot \frac{d {i}_{i μ}}{d t} = {i}_{r} \cdot cos ( {ɛ}_{r} - {ϕ}_{i} ) + {k}_{sr} \cdot {i}_{yh} \cdot cos ( {ϕ}_{yh} - {ϕ}_{i} ) , & Equ . 29 \\ {i}_{i μ} \cdot {τ}_{i} \cdot ( \frac{d {ϕ}_{i }}{d t} - {ω}_{2} ) = {i}_{r} \cdot sin ( {ɛ}_{r} - {ϕ}_{i} ) + {k}_{sr} \cdot {i}_{yh} \cdot sin ( {ϕ}_{yh} - {ϕ}_{i} ) . & Equ . 30\end{matrix}$$

Equation 25 is split correspondingly into two equations: one for the amplitude i_{oμ} and the other for the phase φₒ of the magnetization current \vec{i}_{oμ}^{s}.

$$\begin{matrix}{i}_{o μ} + {τ}_{o} \cdot \frac{d {i}_{o μ}}{d t} = {i}_{s} \cdot cos ( {ɛ}_{s} - {ϕ}_{o} ) - {i}_{yh} \cdot cos ( {ϕ}_{yh} - {ϕ}_{o} ) , & Equ . 31 \\ {i}_{o μ} \cdot {τ}_{o} \cdot ( \frac{d {ϕ}_{o }}{d t} - {ω}_{2} ) = {i}_{s} \cdot sin ( {ɛ}_{s} - {ϕ}_{o} ) - {i}_{yh} \cdot sin ( {ϕ}_{yh} - {ϕ}_{o} ) . & Equ . 32\end{matrix}$$

Finally Equ. 26 is formulated correspondingly as

$${L}_{yh} ( t ) \cdot {i}_{yh} \cdot D ( {ϕ}_{yh} ) ( \begin{matrix}1 \\ 0\end{matrix} ) = {L}_{o} \cdot {i}_{o μ} \cdot D ( {ϕ}_{o} ) ( \begin{matrix}1 \\ 0\end{matrix} ) - {k}_{sr} \cdot {L}_{i} \cdot {i}_{i μ} \cdot D ( {ϕ}_{i} ) ( \begin{matrix}1 \\ 0\end{matrix} ) . \qquad Equ . 33$$

The underlying concept of field-oriented regulation for the EVT is set out below. The aim of the field-oriented regulation of the EVT is to control the amplitudes and phases of the stator and rotor currents, i.e. iₛ(t), iᵣ(t), εₛ(t) and εᵣ(t), in such a manner that the trajectories of the target torques Tᵢₜ and Tₒₜ are followed as quickly and closely as possible, while the amplitudes of the magnetization currents i_{iμ} and i_{oμ} are kept at predefined values (these values can vary over time but in practice this happens relatively slowly, so that we can assume them to be constant here).

As mentioned above, the essential aspect of the field-oriented regulation of an induction machine is the introduction of two control variables e₁ and e₂, so that
(i) The transfer function of

$$( \begin{matrix}{e}_{1} ( t ) \\ {e}_{2} ( t )\end{matrix} )$$

to the magnetization current i_{μ}(t) is linear and time-invariant,
(ii) The transfer function of

$$( \begin{matrix}{e}_{1} ( t ) \\ {e}_{2} ( t )\end{matrix} )$$

to the torque T(t) is bilinear.

If we remove φ^{s} from the diagram according to FIG. 2, the transfer function of

$$( \begin{matrix}{e}_{1} ( t ) \\ {e}_{2} ( t )\end{matrix} ) to ( \begin{matrix}{i}_{μ} ( t ) \\ T ( t )\end{matrix} )$$

of an induction machine with field-oriented regulation can be shown according to FIG. 7. FIG. 7 shows an abbreviated input-output block diagram 40 of an induction machine decoupled by field-oriented regulation. In a field-oriented regulation schedule of the EVT we introduce control variables eᵢ₁, eₒ₁, eᵢ₂ and eₒ₂ in such a manner that the transfer function of the controlled system is decoupled from

$$( \begin{matrix}{e}_{i 1} ( t ) \\ {e}_{i 2} ( t ) \\ {e}_{o 1} ( t ) \\ {e}_{o 2} ( t )\end{matrix} ) to ( \begin{matrix}{i}_{i μ} ( t ) \\ {T}_{i} ( t ) \\ {i}_{o μ} ( t ) \\ {T}_{o} ( t )\end{matrix} )$$

according to FIG. 8. FIG. 8 shows the abbreviated input-output block diagram of an EVT 50 decoupled by field-oriented regulation. Such control variables are defined by

eᵢ₁:=iᵣ·cos(εᵣ−φᵢ)+kₛᵣ·i_{yh}·cos(φ_{yh}−φᵢ), Equ. 34

eᵢ₂:=iᵣ·sin(εᵣ−φᵢ), Equ. 35

eₒ₁:=iₛ·cos(εₛ−φₒ)−i_{yh}·cos(φ_{yh}−φₒ), Equ. 36

eₒ₂:=iₛ·sin(εₛ−φₒ). Equ. 37

With these control variables the torques and magnetization currents assume their target values in stationary operation, if we make

eᵢ₁ equal to the target value for the amplitude of the magnetization current i_{iμ} and
eᵢ₂ equal to the target value for the torque Tᵢ divided by the magnetization current amplitude i_{iμ} multiplied by Kᵢ₂,
eₒ₁ equal to the target value for the amplitude of the magnetization current i_{oμ} and
eₒ₂ equal to the target value for the torque Tₒ divided by the amplitude of the magnetization current i_{oμ} multiplied by Kₒ₂.

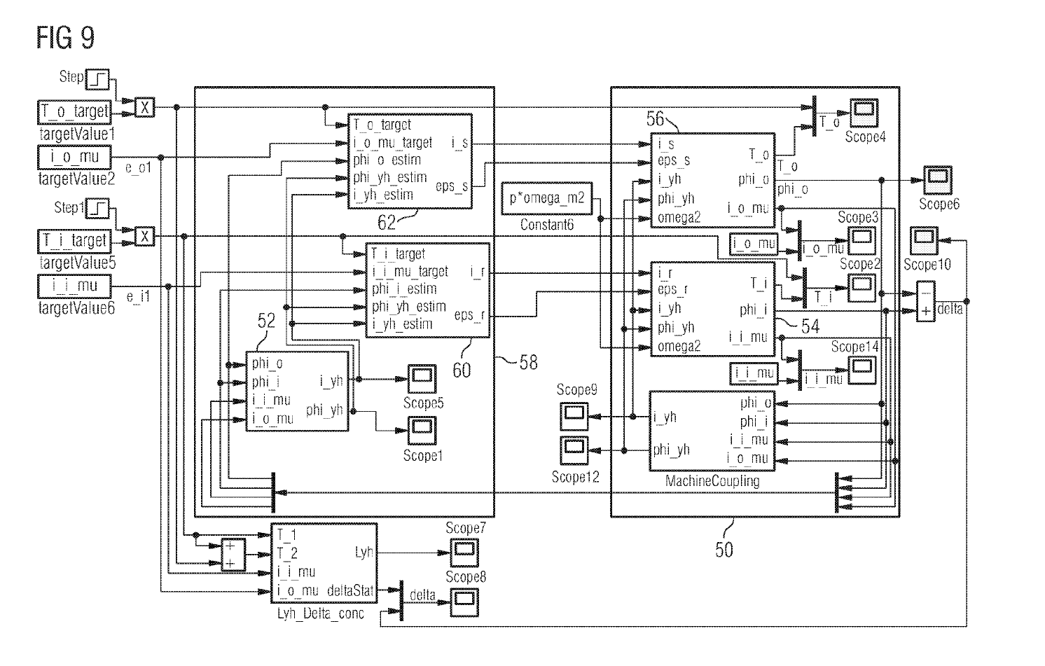

FIG. 9 shows a simulink model of the EVT with corresponding field oriented regulation or control (FOC). Comparing FIG. 9 with FIG. 3 produces the following differences:
(i) For the FOC-decoupling of an induction machine it was sufficient to observe and feed back the phase of the magnetization current, the amplitude of the magnetization current was not required. In the case of the EVT 50 however both the phase and the amplitude of the two magnetization currents have to be known to allow decoupling.
(ii) There is a machine coupling model 52, which shows the coupling between the inner 54 and outer 56 induction machines and is contained in the regulator 58. Obviously there is no corresponding element in the field-oriented regulator of the simple induction machine.

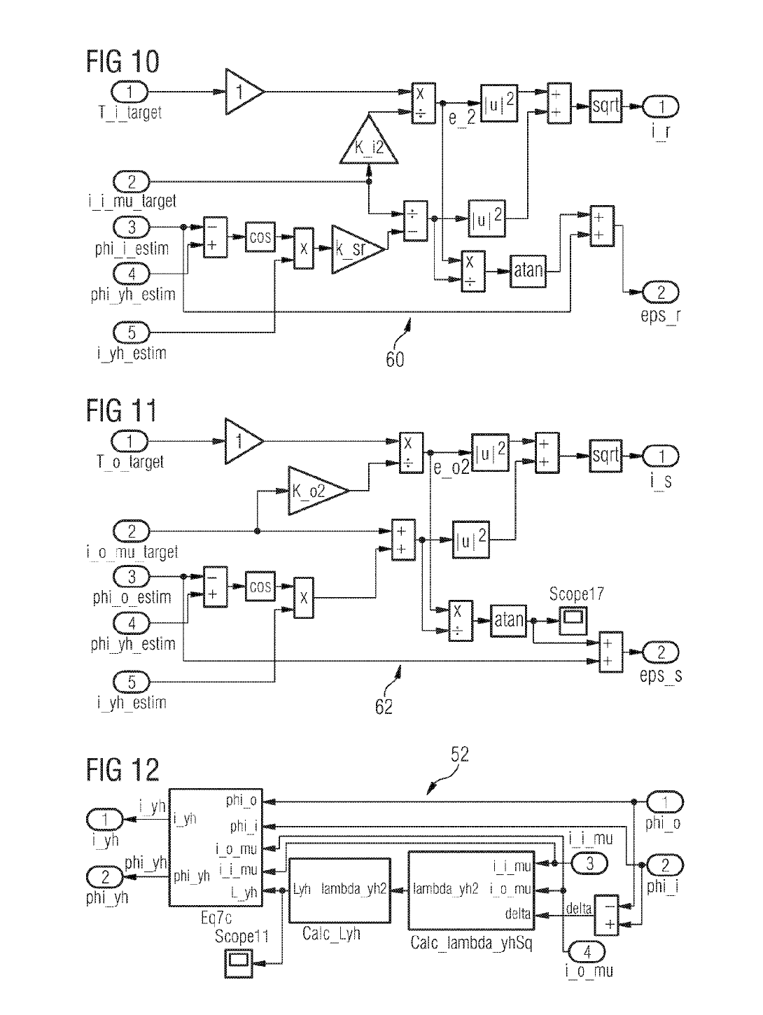

FIGS. 11, 12 and 13 show the individual blocks from FIG. 9 in more detail. FIG. 10 shows the block “regulator inner machine” 60 from FIG. 9, FIG. 11 shows the block “regulator outer machine” 62 from FIG. 9, FIG. 12 shows the block “machine coupling model” from FIG. 9.

It should be noted that all the transfer functions shown in FIGS. 11 to 13, which together make up the regulator from FIG. 9, are static. The complete regulator, which additionally contains an observer for the two magnetization currents and possibly a prefilter for the control variables, is of course dynamic.

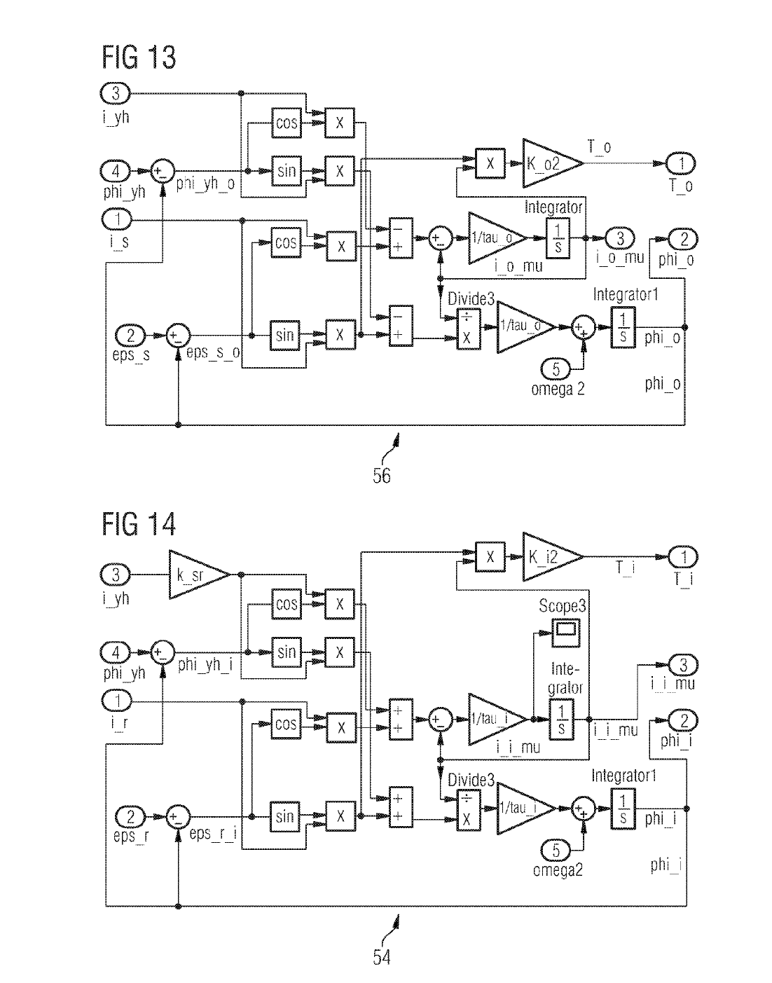

FIG. 13 shows the block “outer machine” 56 from FIG. 9 and FIG. 14 shows the block “inner machine” 54 from FIG. 9.

What is claimed is:

1. A regulator for regulating an electric variable transmission, with the transmission comprising two coupled asynchronous machines, each comprising:
a rotatable rotor, which can be supplied with rotor current to generate a first electromagnetic field,
a stator, which can be supplied with stator current to generate a second electromagnetic field,
an interrotor interacting with the first and second electromagnetic fields, with a first and second cage for conducting first and second magnetization currents induced by the first and second electromagnetic field,
with the rotor and interrotor interacting by way of a first electric torque and the interrotor and stator interacting by way of a second electric torque,
and with the regulator comprising:
a decoupling network, which can be connected upstream of the electric transmission, with the input variables: setpoint value for level of first magnetization current and setpoint value for level of second magnetization current, setpoint value for first torque and setpoint value for second torque and the output variables: rotor current and stator current,
a recording facility to record the first and second magnetization currents,
a feedback facility to feed back the first and second magnetization currents as input variables of the decoupling network.

2. The regulator according to claim 1, wherein the recording facility is an observer simulating the first and second magnetization currents in respect of regulation.

3. The regulator according to claim 1, with a decoupling network, comprising:
a machine coupling model to determine an interrotor coupling current from the first and second magnetization currents,
a rotor controller to determine the rotor current from the interrotor coupling current, the phase of the first magnetization current, the setpoint values for the level of the first magnetization current, and for the first torque,
a stator controller to determine the stator current from the interrotor coupling current, the phase of the second magnetization current, the setpoint values for the level of the second magnetization current and for the second torque.

4. The regulator according to claim 1, wherein both asynchronous machines being coupled mechanically in the transmission.

5. The regulator according to claim 1, wherein both asynchronous machines having a shared interrotor in the transmission.

6. The regulator according to claim 5, wherein the interrotor being arranged concentrically between the stator and rotor and the first and second cages being arranged concentrically in the transmission.

7. The regulator according to claim 6, wherein the first and second cages having a shared yoke in the transmission.

8. A method for regulating an electric variable transmission, with the transmission comprising two coupled asynchronous machines, each having:
a rotatable rotor, which can be supplied with rotor current to generate a first electromagnetic field,
a stator, which can be supplied with stator current to generate a second electromagnetic field,
an interrotor interacting with the first and second electromagnetic fields, with a first and second cage for conducting first and second magnetization currents induced by the first and second electromagnetic fields,
with the rotor and interrotor interacting by way of a first electric torque and the interrotor and stator interacting by way of a second electric torque,
the method comprising the steps of:
determining by a decoupling network, which can be connected upstream of the electric transmission, output variables: rotor current and stator current from input variables: setpoint value for level of first magnetization current, setpoint value for level of second magnetization current, setpoint value for first torque and setpoint value for second torque,
recording by a recording facility the first and second magnetization currents,
feeding back by a feedback facility the first and second magnetization currents as input variables to the decoupling network.

9. The method according to claim 8, wherein the first and second magnetization currents are determined by an observer simulating these in respect of regulation and operating as a recording facility.

10. The method according to claim 8, wherein in the decoupling network:
a machine coupling model determines an interrotor coupling current from the first and second magnetization currents,
a rotor controller determines the rotor current from the interrotor coupling current, the phase of the first magnetization current, the setpoint values for level of the first magnetization current and for first torque,
a stator controller determines the stator current from the interrotor coupling current, the phase of the second magnetization current, the setpoint values for level of the second magnetization current and for second torque.

11. The method according to claims 8, wherein both asynchronous machines being coupled mechanically in the transmission.

12. The method according to claims 8, wherein both asynchronous machines having a shared interrotor in the transmission.

13. The method according to claim 12, wherein the interrotor being arranged concentrically between the stator and rotor and the first and second cages being arranged concentrically in the transmission.

14. The method according to claim 13, wherein the first and second cages having a shared yoke in the transmission.

15. A regulator for regulating an electric variable transmission, with the transmission comprising two coupled asynchronous machines, each comprising:
a rotatable rotor,
a stator,
an interrotor, with a first and second cage for conducting first and second magnetization currents,
with the rotor and interrotor interacting by way of a first electric torque and the interrotor and stator interacting by way of a second electric torque,
and with the regulator comprising:
a decoupling network connected upstream of the electric transmission, having input variables: setpoint value for level of first magnetization current and setpoint value for level of second magnetization current, setpoint value for first torque and setpoint value for second torque and output variables: rotor current and stator current,
a recording device to record the first and second magnetization currents,
a feedback device to feed back the first and second magnetization currents as input variables of the decoupling network.

16. The regulator according to claim 15, wherein the recording device is an observer simulating the first and second magnetization currents in respect of regulation.

17. The regulator according to claim 15, with a decoupling network, comprising:
a machine coupling model to determine an interrotor coupling current from the first and second magnetization currents,
a rotor controller to determine the rotor current from the interrotor coupling current, the phase of the first magnetization current, the setpoint values for the level of the first magnetization current, and for the first torque,
a stator controller to determine the stator current from the interrotor coupling current, the phase of the second magnetization current, the setpoint values for the level of the second magnetization current and for the second torque.

18. The regulator according to claim 15, wherein both asynchronous machines being coupled mechanically in the transmission.

19. The regulator according to claim 15, wherein both asynchronous machines having a shared interrotor in the transmission.

20. The regulator according to claim 19, wherein the interrotor being arranged concentrically between the stator and rotor and the first and second cages being arranged concentrically in the transmission.
